(19) United States
(12) Patent Application Publication
(10) Pub. No.: US 2026/0129255 A1
(43) Pub. Date: May 7, 2026

(54) SEAMLESS MOBILE AUDIO-VIDEO RELAY TECHNOLOGY FOR MICROPHONE-CAMERA INTEGRATION AND CONTROL

(71) Applicant: Alabama A&M University, Normal, AL (US)

(72) Inventors: Raziq Yaqub, Lumberton, NJ (US); Chance Glenn, Huntsville, AL (US); Majed Dweik, Owens Cross Roads, AL (US)

(21) Appl. No.: 19/377,888

(22) Filed: Nov. 3, 2025

Related U.S. Application Data
(60) Provisional application No. 63/715,513, filed on Nov. 1, 2024.

(51) Int. Cl. H04N 21/414; H04N 21/41

(52) U.S. Cl. CPC H04N 21/41415; H04N 21/4126

(57) ABSTRACT

An A/V relay system can integrate the user devices of attendees at a venue with the venue A/V system such that the user devices can be used as cameras and/or microphones with the venue A/V system. The A/V relay system enables an attendee at a venue to use their user device as a camera and/or microphone such that the attendee can be seen on one or more displays at the venue and/or heard at the venue via a sound system having one or more speakers. The user devices can communicate with a server/hub via a network. The server/hub can then relay the audio and/or video from the user devices to the venue A/V system for subsequent presentation to the attendees at the venue via the display(s) and/or sound system.

### CROSS-REFERENCE TO RELATED APPLICATIONS

This application claims the benefit of U.S. Provisional Patent Application No. 63/715,513, filed Nov. 1, 2024, and entitled “Seamless Mobile Audio-Video Relay Technology for Mic-Camera Integration and Control (SMARTMIC),” which application is hereby incorporated by reference herein in its entirety.

### BACKGROUND

The present application generally relates to an A/V (audio/video) relay system. More specifically, the present application is directed to an A/V relay system that can integrate the microphones and cameras of users'mobile devices with an A/V system at a venue where the users are visiting.

In venues like conferences, lecture halls, and entertainment spaces, fostering smooth, interactive audience participation poses logistical and cost challenges. Traditional microphone setups often require costly equipment rentals and can be cumbersome, as traditional microphone setups rely on passing a microphone or having participants move to a fixed station. Additionally, the venue camera operator frequently struggles to locate and focus on the person speaking, and camera placement or angle limitations can make it challenging to capture the speaker's face clearly. These approaches hinder accessibility and disrupt the natural flow of interaction, particularly in large venues. The traditional setups can stall discussions, reduce engagement, and make participation difficult for attendees seated farther away. Additionally, maintaining sound quality and moderating content to prevent disruptions requires constant staff oversight. Alternatives, such as submitting questions through a “web app”, lack the immediacy and connection of in-person engagement, often diminishing spontaneity and discouraging follow-up questions.

Therefore, what is needed is techniques for transforming venue attendees' smartphones into integrated, venue connected microphones and cameras, providing an immediate, accessible, and enriched way for attendees to participate at the venue.

### SUMMARY

The present application generally pertains to a system for seamless mobile audio-video relay technology for mic-camera integration and control (the SMARTMIC system). The SMARTMIC system can transform venue attendees'mobile devices into integrated microphones and cameras, thereby enabling direct audio and video relay to venue sound and display systems. The SMARTMIC system can be used in environments such as conferences, classrooms, and entertainment venues and allows attendees to use their smartphones to transmit audio directly through the venue's sound system when asking questions, while optionally sharing live video, profile images, or screen content on the venue's display. The SMARTMIC system can be configured to have the venue's central display feature either the attendee's content alone or a split screen with both the attendee and main speaker for a dynamic experience. Leveraging secure IoT (Internet of Things) protocols, real-time streaming, and advanced AI (artificial intelligence) capabilities, including voice recognition, noise suppression, sentiment analysis, and content moderation, the SMARTMIC system ensures smooth, engaging interactions. If inappropriate content is detected, AI in the SMARTMIC system can instantly mute and pause video to maintain a focused environment.

In one aspect, the SMARTMIC system transforms smartphones into intelligent, integrated microphones and cameras, bridging mobile devices with venue audio-visual systems for seamless interaction and real-time visual engagement. The SMARTMIC system can integrate advanced software and hardware components that enable high-quality audio and video integration. With the SMARTMIC system, attendees at a venue can activate their smartphone's microphone to ask a question, and, if desired, share live video, profile images, or even their screen content on the venue's central display. The SMARTMIC system enables a split-screen or full-screen view on the venue's display to feature one or both of the attendee and main speaker, fostering an inclusive, dynamic experience. In large venues, the SMARTMIC system enhances visual engagement and facilitates deeper interaction. Attendees can even display figures or images to accompany their questions, adding substance to discussions. The SMARTMIC system can leverage secure IoT (Internet of Things) and streaming protocols to synchronize audio and video through the venue's systems in real time. The SMARTMIC system integrates AI-driven analysis to moderate content instantly, identifying and muting disruptive material to maintain a respectful environment.

In other aspects, the SMARTMIC system revolutionizes event engagement by integrating AI, IoT, and multimedia capabilities, turning mobile devices into versatile microphones and cameras. The SMARTMIC system offers a smooth, high quality experience in various settings—education, corporate events, and entertainment—boosting accessibility, engagement, and operational efficiency.

An advantage of the present application is that the system can provide a scalable, cost-effective solution that improves engagement, simplifies event logistics, and supports versatile, high-quality communication across a range of settings.

Another advantage of the present application is that the system adds context and visual depth to discussions, enhancing interaction.

A further advantage of the present application is that by offering a seamless, engaging, and safe interaction platform, the system can provide a new benchmark in audience participation, meeting a critical need in large-scale communication systems.

Still another advantage of the present application is that the system can establish secure connectivity for real-time, low-latency audio and video streaming, provide content moderation effectiveness, user experience consistency, and interaction control across diverse device types.

Yet another advantage of the present application is that the system is an interactive solution for seamless audio-visual engagement in live venues.

An advantage of the application is that by leveraging participants'smartphones for both audio and video input, the system reduces the need for traditional venue audio-visual systems, cutting down on rental, setup, and maintenance costs. With fewer dedicated audio-visual devices needed, the system supports environmentally friendly practices, reducing waste, transportation, and maintenance-related emissions, making it an efficient and sustainable option for large events.

Other features and advantages of the present application will be apparent from the following more detailed description of the identified embodiments, taken in conjunction with the accompanying drawings which show, by way of example, the principles of the application.

### BRIEF DESCRIPTION OF THE DRAWINGS

FIG. 1 is a schematic diagram of an embodiment of an A/V relay system used at a venue.

FIG. 2 is a schematic diagram of an embodiment of the A/V relay system showing the relationship of components of the A/V relay system.

FIG. 3 is a block diagram of an embodiment of the server/hub for the A/V relay system.

FIG. 4 is a block diagram of an embodiment of the user device for the A/V relay system.

Wherever possible, the same reference numbers are used throughout the drawings to refer to the same or like parts.

### DETAILED DESCRIPTION

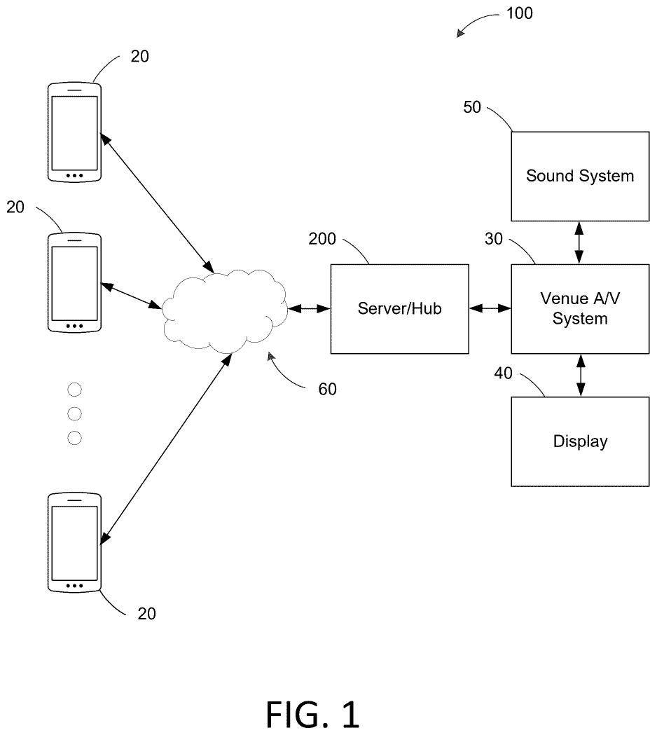

FIG. 1 shows an embodiment of an A/V (audio/video) relay system used at a venue. An A/V relay system 100 can integrate the user devices 20 of attendees at a venue with the venue A/V system 30 such that the user devices 20 can be used as cameras and/or microphones with the venue A/V system 30. The A/V relay system 100 enables an attendee at a venue to use their user device 20 as a camera and/or microphone such that the attendee can be seen on one or more displays 40 at the venue and/or heard at the venue via a sound system 50 having one or more speakers. The user devices 20 can communicate with a server/hub 200 via a network 60. The server/hub 200 can then relay the audio and/or video from the user devices 20 to the venue A/V system 30 for subsequent presentation to the attendees at the venue via the display(s) 40 and/or sound system 50.

In some embodiments, the network 60 may be of any suitable type, including individual connections via the Internet such as cellular or WiFi networks. In other embodiments, the network 60 may connect user devices 20 using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In further embodiments, however, the information being transmitted may be less personal, and therefore the network connections may be selected for convenience over security.

In some embodiments, the user devices 20 can include one or more of a mobile device, smart phone, tablet computer, laptop computer, smart wearable device, other mobile computing device, or any other device capable of capturing audio and/or video information from a user and communicating with the network 60. In other embodiments, the user devices 20 may include or incorporate electronic communication devices for hearing or vision impaired users. According to some embodiments, the user device 20 may include environmental sensors for obtaining audio or visual data, such as a microphone and/or digital camera, and a geographic location sensor for determining the location of the user device 20.

In some embodiments, the server/hub 200 can be located at the venue to better facilitate communication between the user devices 20 and the venue A/V system 30. In one embodiment, the server/hub 200 can be integrated into the venue A/V system 30. However, in other embodiments, the server/hub 200 may be hosted in a cloud computing environment (not shown). The cloud computing environment may provide software, data access, data storage, and computation. Furthermore, the cloud computing environment may include resources such as applications (apps), virtual machines, virtualized storage, or hypervisors. User devices 20 may be able to interact with server/hub 200 using specialized software and/or the cloud computing environment.

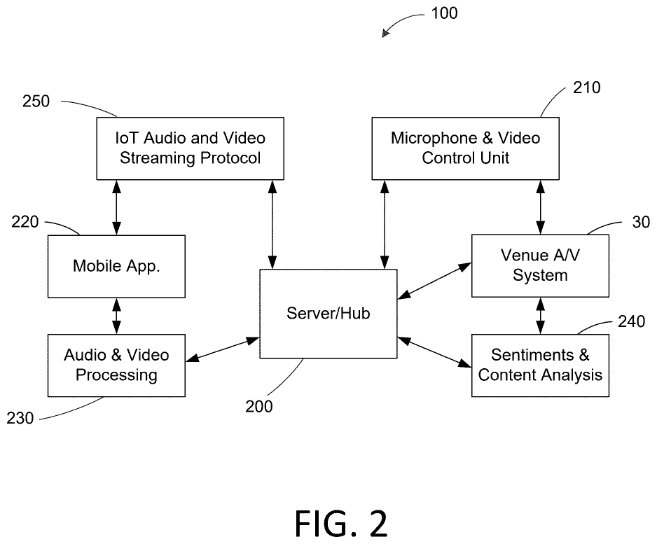

FIG. 2 shows an embodiment of the components of the A/V relay system. The A/V relay system 100 has a central server/hub 200 (i.e., a dedicated server or cloud-based IoT (Internet of Things) hub) to efficiently manage all incoming audio and video signals from attendees' mobile devices 20. The server/hub 200 handles attendee's queue, user authentication and access control, verifying each device's permissions to access the venue's A/V system 30. Audio and video signals are routed to the venue's sound system 50 and central display 40 with real-time synchronization, integrating AI-driven functionalities like content filtering, sentiment analysis, and tone detection to maintain an appropriate and focused environment. The AI algorithms of the server/hub 200 identify disruptive materials, enabling instant muting, pausing, or removal to ensure smooth event flow.

The server/hub 200 can have an embedded microphone and video control unit (MVCU) 210, which, in one embodiment, is a microcontroller that processes audio and video data received from mobile devices and applies audio filtering, noise reduction, and amplification for optimal clarity. The MVCU 210 can route video feeds or screen content from attendees' mobile device 20 to the venue's central display 40, which can be configured as a full-screen or split-screen view alongside the main speaker or sound system 50, enhancing audience engagement. Integrated AI models in the server/hub 200 works with the MVCU 210 to screen live audio and video content in real time, halting inappropriate material instantly by detecting disruptive tones or visual content.

The mobile application (app) 220, which can be developed with cross-platform frameworks like Flutter or React Native, features an intuitive UI (user interface) that lets attendees activate microphones, toggle video settings, share screens, and join an interaction queue. Secure REST APIs (application programming interfaces) and WebSocket protocols in the mobile application 220 enable fast, real-time data exchange, with the backend of the mobile application 220 managing session control, prioritizing speaking requests, and ensuring secure, low-latency data transfer.

The server/hub 200 can have an audio and video processing 230 built with languages like Python or Node.js that manages the real-time synchronization of audio and video streams and can have sentiments and content analysis 240 that applies AI-powered tone and sentiment analysis using NLP (natural language processing) models to moderate interactions. The audio/video processing 230 and/or the sentiment and content analysis can have integrated computer vision algorithms to continuously monitor video content, instantly pausing or removing any unrelated visuals to maintain decorum. The server/hub 200 can handle AI and ML (machine learning) model training. In some embodiments, the AI algorithms of the server/hub 200 also undergo ongoing training with diverse datasets, improving audio noise reduction, tone detection accuracy, and visual content filtering capabilities over time. Regular model updates ensure high responsiveness to mobile device integrated dynamic venue environments.

The server/hub 200 can have an IoT audio and video streaming protocols 250 that utilizes protocols like MQTT and WebSocket to connect the mobile devices 20 with the hardware of the venue A/V system 30 to automate user connection upon arrival and disconnection after each session. The IoT audio and video streaming protocols 250 support synchronized data flow and ensure secure device management for a cohesive user experience. The IoT audio and video streaming protocols 250 automatically deregister devices after each session, enhancing security and preventing unauthorized access.

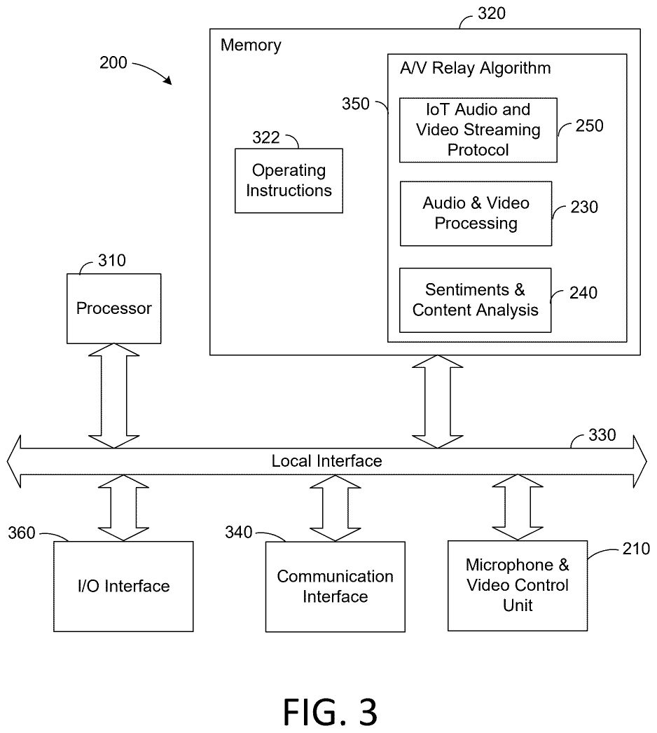

FIG. 3 is a block diagram of an embodiment of the server/hub for the A/V relay system. The server/hub 200 can include one or more processors 310 to control the operations of the components of the server/hub 200. As described herein, a processor 310 may include any suitable processing device such as a general-purpose processor or microprocessor executing instructions from memory, hardware implementations of processing operations (e.g., hardware implementing instructions provided by a hardware description language), any other suitable processor, or any combination thereof. In one embodiment, processor 310 may be a microprocessor that executes instructions stored in memory 320. Memory 320 includes any suitable volatile or non-volatile memory capable of storing information (e.g., instructions and data for the operation and use of the server/hub 200), such as RAM, ROM, EEPROM, flash, magnetic storage, hard drives, any other suitable memory, or any combination thereof.

The processor 310 may be in communication with other components of the server/hub 200 via an internal communication interface 330. Internal communication interface 330 may include any suitable interfaces for providing signals and data between processor 310 and the other components of the server/hub 200. This may include communication buses such as I2C, SPI, USB, UART, GPIO and Ethernet. The server/hub 200 may also include the microphone and video control unit 210 and a communication interface 340 to provide for wireless or wired communications with the other components of the A/V relay system 100 (e.g., user devices 20, venue A/V system 30, display 40, sound system 50, etc.). In one embodiment, communication interface 340 may include a wireless interface that communicates using a standardized wireless communication protocol (e.g., Wi-Fi, ZigBee, Bluetooth®, Bluetooth® low energy, Cellular, etc.) or a proprietary wireless communication protocol operating at any suitable frequency such as 900 MHz, 2.4 GHz, or 5.6 GHz.

The server/hub 200 can include an input/output (I/O) interface 360 for receiving inputs from the user or administrator and providing outputs to the user or administrator as may be desired. In some embodiments, the server/hub 200 may also include one or more I/O devices that connect to one or more interfaces of the I/O interface 360 to enable receiving signals or input from devices and providing signals or output to one or more devices to thereby permit data to be received and/or transmitted by the server/hub 200. For example, the I/O interface 160 of the server/hub 200 may include interface components, which may provide interfaces to one or more input devices, such as one or more displays, keyboards, mouse devices, graphical user interfaces, such as a touchscreen display, track pads, trackballs, scroll wheels, digital cameras, microphones, sensors, and the like, that enable the server/hub 200 to provide information and data to and receive information and data from a user or administrator.

In one embodiment, memory 320 of the server/hub 200 may include memory for executing instructions with processor 310, memory for storing data, and a plurality of sets of instructions to be executed by processor 310. Although memory 320 may include any suitable instructions, in one embodiment the instructions may include operating instructions 322 for generally controlling the operation of the server/hub 200 and an A/V relay algorithm 350, which can include audio and video processing 230, sentiments and content analysis 240, and IoT audio and video streaming protocols 250, to facilitate the transfer of audio and/or video signals between the user devices 20 and the venue A/V system 30. In addition, the IoT audio and video streaming protocols 250 can include an IoT hub configured to authenticate user devices 20 and manage access control.

The operating instructions 322 and/or the A/V relay algorithm 350 (including the audio and video processing 230, sentiments and content analysis 240, and IoT audio and video streaming protocols 250) can be implemented in software, hardware, firmware, or any combination thereof. In the server/hub 200 shown by 3, the operating instructions 322 and/or the A/V relay algorithm 350 can be implemented in software and stored in memory 320. When the operating instructions 322 and/or the A/V relay algorithm 350 are implemented in software, the processor 310 may execute instructions of the operating instructions 322 and/or the A/V relay algorithm 350 to perform the functions ascribed herein to the corresponding components. However, other configurations of the operating instructions 322 and/or the A/V relay algorithm 350 are possible in other embodiments. Note that the operating instructions 322 and/or the A/V relay algorithm 350, when implemented in software, can be stored and transported on any computer-readable medium for use by or in connection with an instruction execution apparatus that can fetch and execute instructions. In the context of this document, a “computer-readable medium” can be any non-transitory means that can contain or store code for use by or in connection with the instruction execution apparatus. In addition, it is to be understood that the server/hub 200 can include other components not specifically identified herein.

In some embodiments, the A/V relay algorithm 350 (e.g., the audio and video processing 230 and/or the sentiments and content analysis 240) can use AI-driven voice and facial recognition to identify speakers and display their name, affiliation, or social tags on the venue's display 40 alongside live video. This feature personalizes large conferences by adding speaker context, enhancing audience connection, and improving the visibility of each contribution. The A/V relay algorithm 350 (e.g., the audio and video processing 230) can break language barriers by providing live translations and real-time captions that are displayed on display 40 or other video feeds for multilingual or international audiences. Attendees can follow translated captions directly over videos, ensuring an inclusive experience for all participants.

In still other embodiments, the A/V relay algorithm 350 (e.g., the audio and video processing 230 and/or the IoT audio and video streaming protocols 250) can permit users or attendees to customize privacy via the mobile application 220, with options like voice-only or video participation, avatars, profile pictures, or live video displays. Video settings adjust based on user device 20 and network 60 capabilities, delivering a smooth, tailored experience even in large-scale venues. The A/V relay algorithm 350 (e.g., the audio and video processing 230 and/or the sentiments and content analysis 240) can capture audience engagement metrics with real-time video-based sentiment analysis, helping presenters gauge reactions and adapt on the spot. The detection of non-verbal cues, such as expressions, provide immediate insights to a presenter, enriching interaction quality and responsiveness.

In other embodiments, the server/hub 200 can provide support for video, in addition to audio, to enable dynamic user engagement. Attendees can visually interact with presenters or each other via the A/V relay system 100, fostering richer, more interactive exchanges across diverse formats, from Q&As to lectures and performances. The AI-driven sentiments and content analysis 240 of the A/V relay algorithm 350 can extend content moderation to video analysis, filtering inappropriate gestures or disruptive behavior based on real-time video feeds. The filtering of content by the sentiments and content analysis 240 helps moderators maintain a respectful environment while providing automated oversight that detects both verbal and visual cues. In one embodiment, the sentiments and content analysis 240 can incorporate AI-driven real time moderation with an intelligent moderation engine that automatically analyzes live content flow, performing real-time detection, filtering, and control of inappropriate or disruptive audio and video streams. The sentiments and content analysis 240 can provide almost instant auto-muting, pausing, or replacing of content to maintain a focused and respectful environment. In other embodiments, the sentiments and content analysis 240 can include computer vision algorithms configured to detect visual anomalies or unrelated images within the live video stream and automatically suppress the corresponding content from being displayed.

The audio and video processing 230 of the A/V relay algorithm 350 adapts both audio and video quality based on room acoustics, user location, and user device 20 capabilities, ensuring clear sound and stable video. Video resolution can be adjusted automatically for optimal performance, enhancing the experience across different user devices 20 and ensuring high-quality output on large venue displays 40. In some embodiments, the A/V relay algorithm 350 (e.g., the audio and video processing 230) can train machine learning models using audio and video datasets collected from previous sessions to improve noise reduction, tone detection accuracy, and content filtering performance over time.

In yet other embodiments, the combined audio-video platform of the A/V relay algorithm 350 supports diverse settings, including hybrid and remote events, by synchronizing audio and video streams with venue A/V systems. This scalability of the A/V relay algorithm 350 enables seamless audio-visual integration across conference halls, classrooms, entertainment venues, and more. The live video and profile display options of the A/V relay algorithm 350 creates a richer visual connection between the audience and speakers. Users can participate via live video or choose an avatar for privacy, enabling a balance between visibility and individual preference. The A/V relay algorithm 350 makes interactions inclusive by supporting both audio and video streams, complemented by multilingual captions for real-time accessibility. The combination of video and captioning ensures all attendees, including those with hearing or language challenges, can actively engage.

In an embodiment, the A/V relay algorithm 350 can automatically register and deregister user devices 20 upon entry and exit from the venue (i.e., the user device is determined to be a preselected distance from the venue) to ensure session-specific access control and to prevent unauthorized participation. The A/V relay algorithm 350 can provide a customizable feature set with flexible options for local recording, dynamic participant controls, and integration with event or seminar management tools.

In some embodiments, the A/V relay algorithm 350 can provide a localized multi-stream management interface, which can be a control interface for an administrator to manage the audio and video streams of concurrent users within the venue A/V system 30, allowing the administrator to authorize, queue, and prioritize participant contributions. The A/V relay algorithm can provide intelligent queuing and priority microphone assignments to help maintain order in large-group settings. In addition, the A/V relay algorithm 350 can permit the administrator to control speaking permissions, enabling one or multiple participants to speak at a time. The A/V relay algorithm 350 can also provide an administrative interface that allows a moderator or administrator to control participation modes, assign speaking priority, manage queues, and restrict users to audio-only or audio and video-enabled modes.

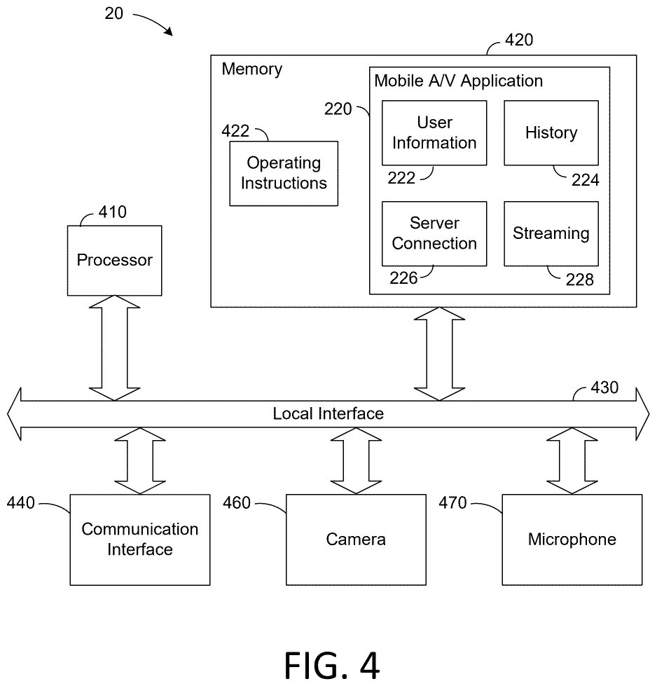

FIG. 4 is a block diagram of an embodiment of the user device for the A/V relay system. The user device 20 can include one or more processors 410 to control the operations of the components of the user device 20. As described herein, a processor 410 may include any suitable processing device such as a general-purpose processor or microprocessor executing instructions from memory, hardware implementations of processing operations (e.g., hardware implementing instructions provided by a hardware description language), any other suitable processor, or any combination thereof. In one embodiment, processor 410 may be a microprocessor that executes instructions stored in memory 420. Memory 420 includes any suitable volatile or non-volatile memory capable of storing information (e.g., instructions and data for the operation and use of the user device 20), such as RAM, ROM, EEPROM, flash, magnetic storage, hard drives, any other suitable memory, or any combination thereof.

The processor 410 may be in communication with other components of the user device 20 via an internal communication interface 430. Internal communication interface 430 may include any suitable interfaces for providing signals and data between processor 410 and the other components of the user device 20. This may include communication buses such as I2C, SPI, USB, UART, GPIO and Ethernet. The user device 20 may also include a camera 460, a microphone 470, and a communication interface 440 that provides for wireless or wired communications with the other components of the A/V relay system 100 (e.g., server/hub 200, etc.). In one embodiment, communication interface 440 may include a wireless interface that communicates using a standardized wireless communication protocol (e.g., Wi-Fi, ZigBee, Bluetooth®, Bluetooth® low energy, Cellular, etc.) or a proprietary wireless communication protocol operating at any suitable frequency such as 900 MHz, 2.4 GHz, or 5.6 GHz.

In one embodiment, memory 420 of the user device 20 may include memory for executing instructions with processor 410, memory for storing data, and a plurality of sets of instructions to be executed by processor 410. Although memory 420 may include any suitable instructions, in one embodiment the instructions may include operating instructions 422 for generally controlling the operation of the control system 400 and a mobile A/V application 220, which can include user information algorithm 222, history algorithm 224, server connection algorithm 226 and a streaming algorithm 228, to optimize the capturing of audio and/or video at the user device 20 and facilitate the transfer of the captured audio and/or video to the A/V relay system 100.

The operating instructions 422 and/or the mobile A/V application 220 (including the user information algorithm 222, history algorithm 224, server connection algorithm 226 and a streaming algorithm 228) can be implemented in software, hardware, firmware, or any combination thereof. In the user device 20 shown by FIG. 4, the operating instructions 422 and/or the mobile A/V application 220 can be implemented in software and stored in memory 420. When the operating instructions 422 and/or the mobile A/V application 220 are implemented in software, the processor 410 may execute instructions of the operating instructions 422 and/or the mobile A/V application 220 to perform the functions ascribed herein to the corresponding components. However, other configurations of the operating instructions 422 and/or the mobile A/V application 220 are possible in other embodiments. Note that the operating instructions 422 and/or the mobile A/V application 220, when implemented in software, can be stored and transported on any computer-readable medium for use by or in connection with an instruction execution apparatus that can fetch and execute instructions. In the context of this document, a “computer-readable medium” can be any non-transitory means that can contain or store code for use by or in connection with the instruction execution apparatus. In addition, it is to be understood that the user device 20 can include other components not specifically identified herein.

The mobile A/V application 220 can have four main sections or algorithms that guide the user through a structured process. The user information algorithm 222 can provide an initial setup screen that appears only on the first launch of the mobile A/V application 220. Once completed, initial setup screen is not provided to the user again (to ensure user information is collected only once) unless the user clears stored data or reinstalls the mobile A/V application 220. The mobile A/V application 220 can require one or more of the following inputs: 1. name of the user-a text field where the user enters their name; and 2. profile picture-an option to upload or take a profile picture (e.g., via camera or gallery). After the user provides both inputs, the mobile A/V application 220 proceeds to the server connection section 226. In one embodiment, the entered information is stored locally (i.e., on the user device 20) so that the user does not need to re-enter the information on subsequent launches of the mobile A/V application 220. In some embodiments, the user can revisit and modify their personal information (e.g., name and profile picture) from the server connection section 226 before establishing a connection with the server/hub 200. However, once the connection is established, personal information cannot be edited.

The history algorithm 224 can logs all call details, including duration and server, provide a detailed log of all past calls (or connections) to the server/hub 200 and provides an option to clear the history. The log of past calls can include for each call entry: 1. date and time-timestamp of when the call was initiated; 2. call type—indication of whether the call was a video stream or audio-only stream; 3. duration-total duration of the call; 4. server IP (Internet protocol) address-the IP address of the server/hub 200 connected during the call; and 5. status-whether the call was successful, rejected, or failed due to a connection issue. In one embodiment, the user can clear all call logs by tapping a “Clear History” button with a confirmation dialog being displayed to prevent accidental deletion.

The server connection algorithm 226 enables the user to establish a connection with the server/hub 200 by providing the necessary endpoint details. The server connection algorithm 226 also includes an option to re-edit personal information before connecting. In one embodiment, the server connection algorithm 226 can have a user connect to the server/hub 200 by scanning a QR code. The QR code contains the server's endpoint information (e.g., IP address and port). The server connection algorithm 226 scans the QR code using the device's camera and extracts the server details. In another embodiment, the server connection algorithm 226 can have a user manually input the server's IP address and port into designated fields. After selecting either option, the application attempts to connect to the server/hub 200 using WebSockets for real-time communication. If the connection is successful, the server connection algorithm 226 can have a user proceed to the streaming screen or if the connection fails, an error message is displayed, and the user is prompted to retry or correct the input. In some embodiments, before establishing a connection with the server/hub 200, the user can access their previously entered personal information (name and profile picture) and make changes if needed. Once the connection to the server/hub 200 is established, personal information becomes immutable and cannot be modified.

The server connection algorithm 226 can support both QR code scanning and manual input for server details. In addition, the server connection algorithm 226 can provide real-time feedback by displaying connection status, request timestamps, and call duration. In some embodiments, the server/hub 200 maintains a queue of requests to talk and continuously communicates the number of pending requests to the user device 20. The server connection algorithm 226 can provide vibration feedback to alert the user when there is one request ahead in the queue (triggered when the server sends a “notification”: “vibrate” message) and provide a beep sound to notify the user when it is exactly their turn (triggered when the server sends a “notification”: “beep” message).

The streaming algorithm 228 can provide the main operational screen where the user interacts with the live video/audio streaming functionality. Communication with the server/hub 200 is handled using a network protocol that provides full-duplex communication over a single, persistent TCP connection (e.g., WebSockets). In an embodiment, the network protocol can be a local low-latency integration protocol that enables simultaneous, low-latency audio and video relay from multiple attendee smartphones within a venue's local area network (LAN). Unlike conventional internet-based conferencing platforms (e.g., Zoom or Teams), the network protocol of the streaming algorithm 228 eliminates reliance on cloud infrastructure, achieving near-zero communication delay and ensuring seamless, real-time interaction. Upon a successful connection to server/hub 200, the user can request the server/hub 200 to accept either: 1. live video stream-both video and audio are sent to the server/hub 200; or 2. audio stream only-only audio is sent to the server/hub 200. When the user sends a streaming request to talk, the server/hub 200 adds the request to a queue of users wanting to talk. While the request is pending, the streaming algorithm provides or displays: 1. requested time-the timestamp when the request was made; 2. number of pending requests-the server continuously communicates the number of requests ahead of the current user in the queue; 3. time spent waiting-a countdown or timer showing how long the user has been waiting; and 4. user turn notifications-vibration feedback (the mobile device 20 vibrates when there is one request ahead of the user in the queue to alert the user that their turn is approaching) or a beep sound (the mobile device 20 emits a beep sound when it is exactly the user's turn to signal that the user's streaming session is about to begin). Once the server/hub 200 accepts the request from the queue, the front camera of the user device 20 turns on automatically, and the video feed starts live video streaming to the server/hub 200. The user can toggle the camera off, switch cameras, or mute the microphone during the stream with the streaming algorithm 228. The streaming algorithm can display: 1. call duration-a timer showing how long the call has been active; and 2. audio stream only showing a microphone icon with an equalizer animation to indicate that only audio is being streamed. In one embodiment, the user can mute the microphone if needed. The streaming algorithm can provide the following controls during streaming: 1. camera toggle—the ability to turn the camera on/off or switch between front and rear cameras; and 2.microphone mute—the ability to mute/unmute the microphone. Users possess the ability to terminate their streaming sessions from the streaming algorithm 228. In instances where a user's session is perceived as ended by the server/hub 200 but remains active (probably the user forgets to terminate the session), the server/hub 200 automatically end the session to ensure timely service for users waiting in the queue.

In an embodiment, the A/V relay system 100 can provide an integrated system architecture that combines secure IoT streaming, AI-based content moderation, and multi-display dynamic control, enabling flexible visualization modes such as attendee-only view, split-screen interaction, or main-speaker emphasis—all orchestrated within the venue A/V system 30. The A/V relay system 100 can also provide LAN-first functionality, with optional internet-based operation when required, ensuring both network flexibility and administrative control. In addition, the mobile A/V application 220 and the server/hub 220 are configured for cross-platform interoperability, enabling operation across multiple operating systems and device types without manual configuration. In other embodiments, the A/V relay system 100 can provide full privacy and security by having all communications remain confined to the local network by default, ensuring privacy and eliminating reliance on external servers. In one embodiment, the A/V relay system 100 can be used for conference Q&A (question and answer) facilitation and optimization. The A/V relay system 100 transforms attendees' mobile devices 20 into intelligent, interactive microphones/camaras and streamlines Q&A sessions with AI-driven queue management and sentiment-based moderation. The sentiment and relevance analysis provided by the A/V relay system 100 maintains respectful, on-topic discussions aligned with event standards, while noise reduction ensures clear communication in bustling conference settings. Advanced NLP algorithms in the server/hub 200 detect inappropriate audio/video content, enabling immediate alerts or muting based on pre-set criteria, creating a smooth, managed flow in large gatherings.

In another embodiment, the A/V relay system 100 can be used for classroom engagement and accessibility enhancement. In educational environments, the A/V relay system 100 enhances real-time interaction between students and instructors, fostering engagement even in large lecture halls. With personalized audio and video options provided by the A/V relay system 100, instructors can guide participation effortlessly. Automatic speech-to-text and on-screen content display provided by the A/V relay system 100 support accessibility, ensuring inclusivity and providing valuable transcripts for post-session review.

In a further embodiment, the A/V relay system 100 can be used for entertainment venue immersion and vocal enhancement. For karaoke and live entertainment, the A/V relay system 100 turns smartphones into dynamic audio-visual devices. Attendees can follow lyrics on a shared screen, while vocal enhancement features, such as pitch correction, reverb, and harmonization, deliver studio-quality sound. AI-based adjustments provided by the A/V relay system 100 tailor the acoustic profile to suit various venue types, ensuring an immersive experience for performers and audiences alike.

In yet another embodiment, the A/V relay system 100 can be used for hybrid and remote event participation. The IoT integration provided by the A/V relay system 100 connects physical and digital spaces for hybrid events, allowing remote participants to engage as if onsite. Advanced audio management, including noise suppression, echo cancellation, and voice balancing by the A/V relay system 100 ensures seamless interactions and high-quality sound, providing a fully immersive experience for all attendees, regardless of location.

In still another embodiment, the A/V relay system 100 can be used for accessibility support for special needs. The customizable accessibility features of the A/V relay system 100 support hearing-impaired attendees with adaptable audio output and provide visual prompts for speech-impaired users that are efficiently relayed by the venue A/V system 30. Adaptive user interfaces and individualized accessibility settings provided by the A/V relay system 100 make it an ideal tool for inclusive environments, enhancing participation in conferences, classrooms, and entertainment venues dedicated to accessibility.

Although the figures herein may show a specific order of method steps, the order of the steps may differ from what is depicted. Also, two or more steps may be performed concurrently or with partial concurrence. Variations in step performance can depend on the components chosen and on designer choice. All such variations are within the scope of the application.

It should be understood that the identified embodiments are offered by way of example only. Other substitutions, modifications, changes and omissions may be made in the design, operating conditions and arrangement of the embodiments without departing from the scope of the present application. Accordingly, the present application is not limited to a particular embodiment, but extends to various modifications that nevertheless fall within the scope of the application. It should also be understood that the phraseology and terminology employed herein is for the purpose of description only and should not be regarded as limiting.

What is claimed is:

1. A system for relaying audio and video signals comprising:
a mobile A/V application installed on each of a plurality of user devices;
a venue A/V system having a sound system configured to output audio signals and a display configured to output images and video signals;
a server computer in communication with both the mobile A/V application on the plurality of user devices and the venue A/V system, the server computer configured to relay audio and video signals received from a mobile A/V application to the sound system and display of the venue A/V system.

2. The system of claim 1, wherein the mobile A/V application uses a camera and a microphone of the corresponding user device to capture the audio and video signal provided to the server computer.

3. The system of claim 1, wherein the server computer is configured to apply content moderation to the audio and video signals received from the mobile A/V application.

4. The system of claim 1, wherein the server computer is configured to generate a queue when more than one mobile A/V application requests to provide audio and video signals.

5. The system of claim 1, wherein the server computer is communication with the mobile A/V applications on the plurality of user devices via a wireless network.

6. The system of claim 5, wherein the mobile A/V applications on the plurality of user devices use full-duplex communication over a single, persistent TCP connection to communicate with the server computer.
